(19) United States
(12) Patent Application Publication
(10) Pub. No.: US 2007/0274398 A1
(43) Pub. Date: Nov. 29, 2007

(54) Parallelization of Video Decoding on Single-Instruction, Multiple-Data Processors

(75) Inventor: Robert Louis Caulk, Livermore, CA (US)

Correspondence Address: DEMONT & BREYER, LLC, 100 COMMONS WAY, Ste. 250, HOLMDEL, NJ, 07733, US

(73) Assignee: METTA TECHNOLOGY, INC., San Jose, CA (US)

(21) Appl. No.: 11/419,882

(22) Filed: May 23, 2006

(51) Int. Cl. H04N 7/12

(52) U.S. Cl. 375/240.26

(57) ABSTRACT

A method of parallelizing the prediction of H.264 luma blocks is disclosed. The illustrative embodiment, for example, enables the prediction of H.264 luma blocks to be performed in parallel on a single-instruction, multiple-data processor so that any two—and up to all 16 pixels—can be set simultaneously in different execution units. This is very fast and economical. The invention of formulas for enabling the parallelization of the H.264 luma blocks is noteworthy because of the diversity in the structures of the formulas for predicting the various pixels given by the H.264 standard. For example, the standard specifies fundamentally different formulas for some pixels than for others, which makes their parallelization appear impossible.

### FIELD OF THE INVENTION

The present invention relates to information technology in general, and, more particularly, to video decoding and computational complexity.

### BACKGROUND OF THE INVENTION

FIG. 1 depicts a video frame that comprises an image of a person in the prior art. The video frame comprises a two-dimensional array of 720 by 480 8-bit pixels. In some cases, all 345,600 pixels are transmitted when the frame is transmitted, but that requires that 345,600 bytes of data be transmitted for each frame.

There are techniques, however, for reducing, on average, the number of bytes that must be transmitted. One such technique is known as H.264. In accordance with H.264, some of the pixels in a frame are transmitted explicitly while others are not, but are derived or extrapolated from those that are.

To accomplish this, the pixels in the video frame are organized in a hierarchy of data structures. First, the frame is partitioned into a two-dimensional array of 45 by 30 macroblocks, as shown in FIG. 2. In turn, and as shown in FIG. 3, each macroblock is partitioned into a two-dimensional array of 4 by 4 luma blocks, and each luma block is partitioned into a two-dimensional array of 8-bit pixels.

The pixels in each luma block are either transmitted explicitly, or they are derived from the pixels in the luma blocks above it and to its left. When the luma block is predicted, the pixels in the block are designated as shown in FIG. 4, and the pixels that they are based on are designated as shown in FIG. 5. The H.264 standard specifies a variety of techniques for deriving the pixels in the luma block.

The advantage of techniques such as H.264 is that they can significantly reduce the number of pixels that need to be transmitted for a video frame. A disadvantage of H.264 in particular is that the formulas for decoding are complex and slow for a computer to perform. This makes video equipment that can handle H.264 to be expensive and to consume an excessive amount of power (wattage).

Therefore, the need exists for a video compression technique without some of the disadvantages of techniques in the prior art.

### SUMMARY OF THE INVENTION

The present invention enables the prediction of H.264 luma blocks to be performed quickly and without the consumption of an excessive amount of power. The illustrative embodiment, for example, enables the prediction of H.264 luma blocks to be performed in parallel on a single-instruction, multiple-data processor so that any two—and up to all 16 pixels—can be set simultaneously in different execution units. This is very fast and economical.

The invention of formulas for enabling the parallelization of the H.264 luma blocks is noteworthy because of the diversity in the structures of the formulas for predicting the various pixels given by the H.264 standard. For example, the standard specifies fundamentally different formulas for some pixels than for others, which makes their parallelization appear impossible.

The illustrative embodiment comprises: method of parallelizing the Intra_{—}4×4 Diagonal_Down_Left prediction of a 4×4 luma block, pred4×4L[ ], said method comprising: setting pred4×4L[3, 2] using the formula (sample p[5,−1]+sample p[7,−1]+2*(sample p[6,−1])+2)>>2; and setting pred4×4L[3, 3] using the formula (sample p[6,−1]+sample p[7,−1]+2*(sample p[7,−1])+2)>>2.

### BRIEF DESCRIPTION OF THE DRAWINGS

FIG. 1 depicts a video frame that comprises an image of a person in the prior art.

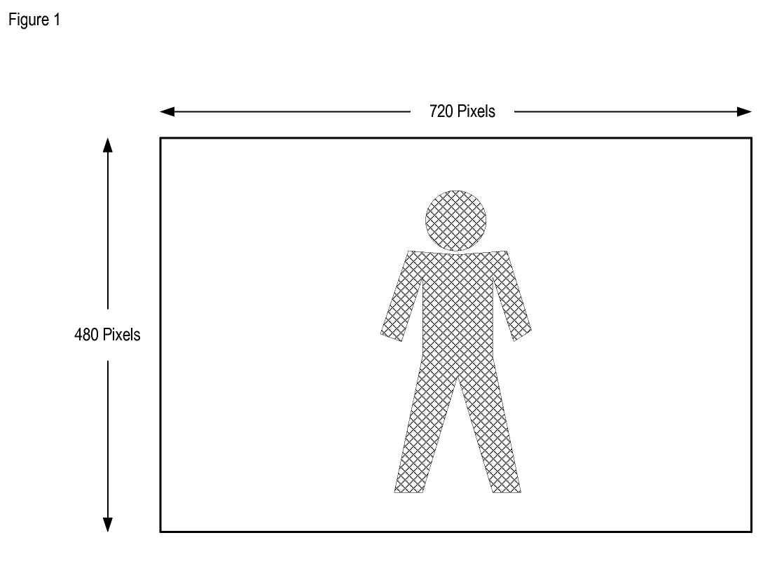

FIG. 2 depicts a video frame that is partitioned into a two-dimensional array of 45 by 30 macroblocks.

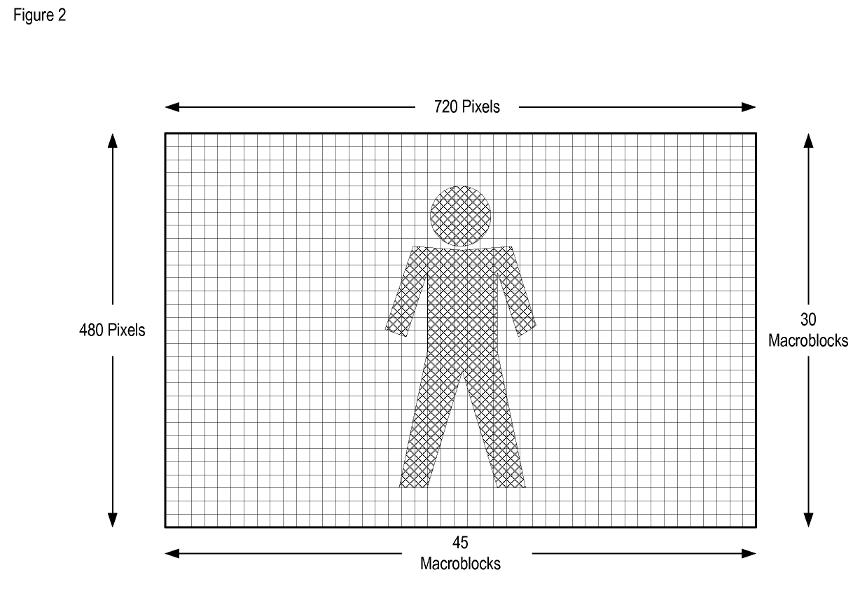

FIG. 3 depicts a macroblock as it is partitioned into luma blocks and pixels.

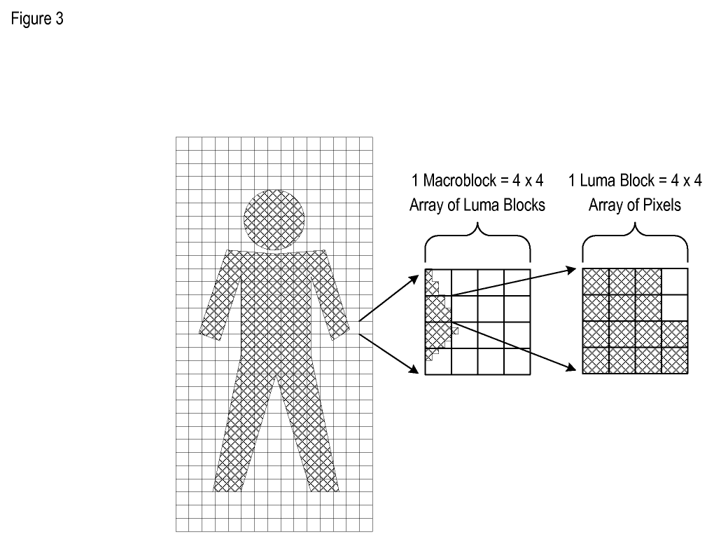

FIG. 4 depicts the designation of the pixels in a luma block.

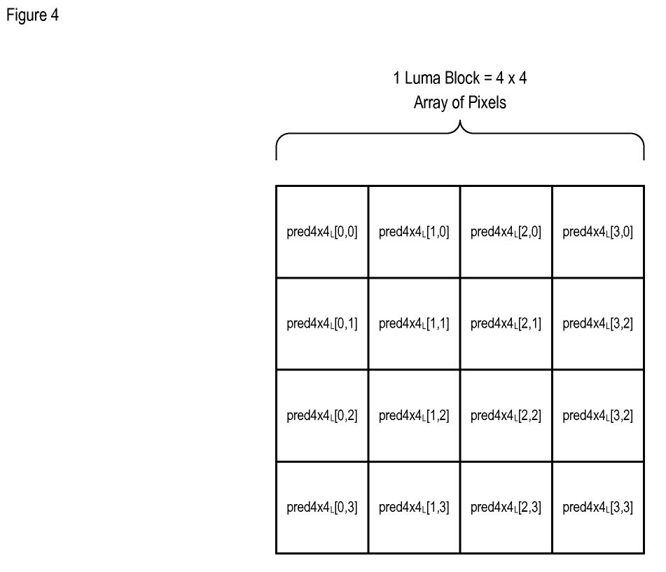

FIG. 5 depicts the designation of the pixels in the luma block with regard to the pixels from which they are derived.

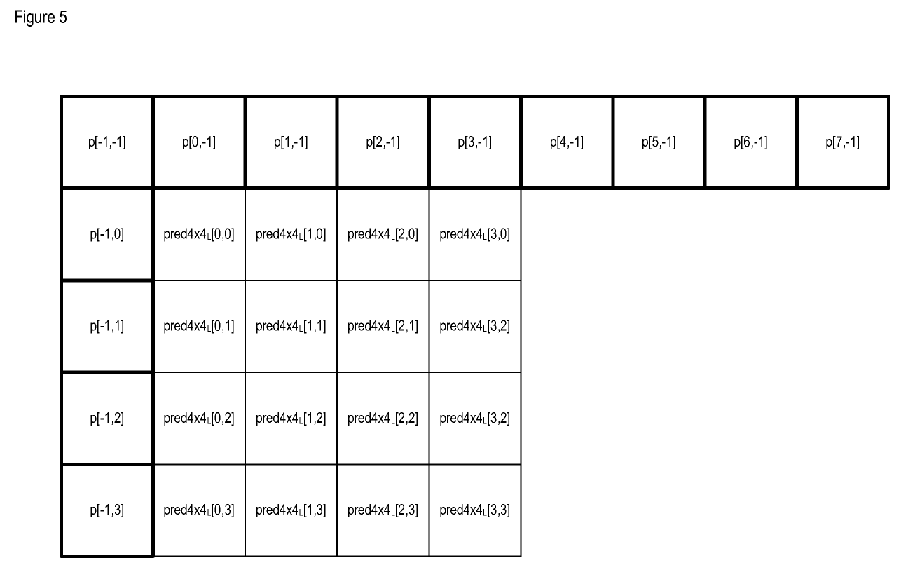

FIG. 6 depicts a graphical illustration of the H.264 Intra_{—}4×4 Diagonal_Down_Left prediction mode.

FIG. 7 depicts a flowchart of the salient operations associated with the parallelization of the H.264 Intra_{—}4×4 Diagonal_Down_Left prediction mode.

FIG. 8 depicts a graphical illustration of the H.264 Intra_{—}4×4_Diagonal_Down_Right prediction mode.

FIG. 9 depicts a flowchart of the salient operations associated with the parallelization of the H.264 Intra_{—}4×4_Diagonal_Down_Right prediction mode.

FIG. 10 depicts a graphical illustration of the H.264 Intra_{—}4×4_Vertical_Right prediction mode.

FIG. 11 depicts a flowchart of the salient operations associated with the parallelization of the H.264 Intra_{—}4×4_Vertical_Right prediction mode.

FIG. 12 depicts a graphical illustration of the H.264 Intra_{—}4×4_Horizontal_Down prediction mode.

FIG. 13 depicts a flowchart of the salient operations associated with the parallelization of the H.264 Intra_{—}4×4_Horizontal_Down prediction mode.

FIG. 14 depicts a graphical illustration of the H.264 Intra_{—}4×4_Vertical_Left prediction mode.

FIG. 15 depicts a flowchart of the salient operations associated with the parallelization of the H.264 Intra_{—}4×4_Vertical_Left prediction mode.

FIG. 16 depicts a graphical illustration of the H.264 Intra_{—}4×4_Horizontal_Up prediction mode.

FIG. 17 depicts a flowchart of the salient operations associated with the parallelization of the H.264 Intra_{—}4×4_Horizontal_Up prediction mode.

### DETAILED DESCRIPTION

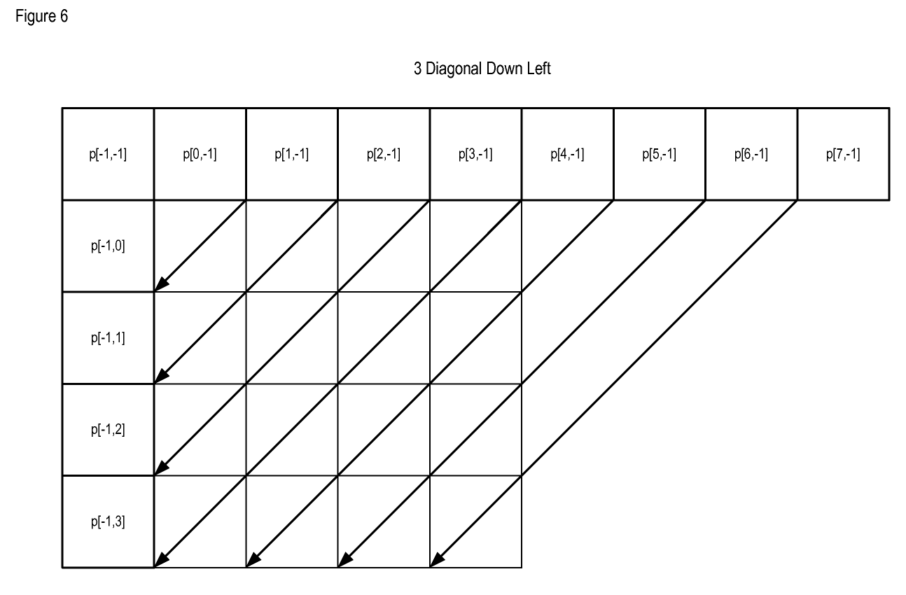

FIG. 6 depicts a graphical illustration of the H.264 Intra_{—}4×4 Diagonal_Down_Left prediction mode, which illustrates that the pixels to be predicted are based on the pixels above them and to the right. Although the parallel lines might appear that the prediction of the pixels is straightforward, there is a substantial difference in the structure of the formulas for predicting the various pixels. In particular, the H.264 standard specifies that:

pred4×4L[3,3]=(p[6,−1]+3*p[7,−1]+2)>>2 (8-51)

and in contrast, the formula for the other 15 pixels is:

pred4×4L[x,y]=(p(x+y,−1]+2*p[x+y+1,−1]+p[x+y+2,−1]+2)>>2 (8-52)

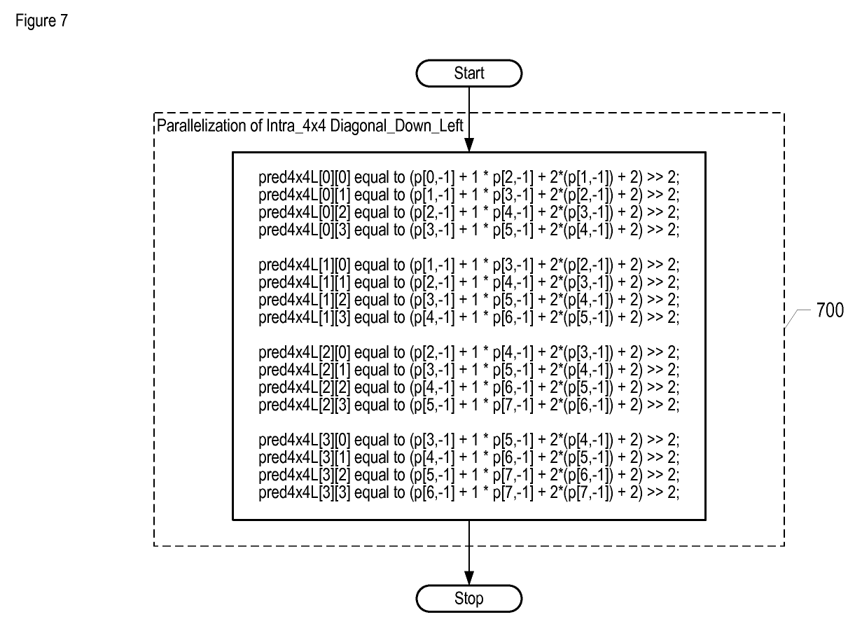

FIG. 7 depicts a flowchart of the salient operations associated with the parallelization of the H.264 Intra_{—}4×4 Diagonal_Down_Left prediction mode.

At task 700, the illustrative embodiment sets all 16 pixels of the array pred4×4L in accordance with the 16 formulas shown in FIG. 7. In accordance with the illustrative embodiment, all 16 pixels of the array pred4×4L are set simultaneously and in parallel in different execution units in a single-instruction, multiple-data processor. It will be clear to those skilled in the art, after reading this specification, how to do this. The ability to parallelize the H.264 Intra_{—}4×4 Diagonal_Down_Left prediction is noteworthy because the formula for predicting pred4×4L[3, 3] has a substantially different structure than the formula for predicting the other 15 pixels. For this reason, the ability to set pred4×4L[3,3] in parallel execution with the other 15 pixels enables the H.264 Intra_{—}4×4 Diagonal_Down_Left prediction to be performed far more quickly on a SIMD processor than it had been previously envisioned.

In some alternative embodiments of the present invention (e.g., in single-instruction/single-data processors, single-instruction/multiple-data processors having fewer than 16 execution units, and multiple-instruction/multiple-data processors having fewer than 16 execution units, etc.) any subcombination of the 16 pixels of the array pred4×4L can be set simultaneously.

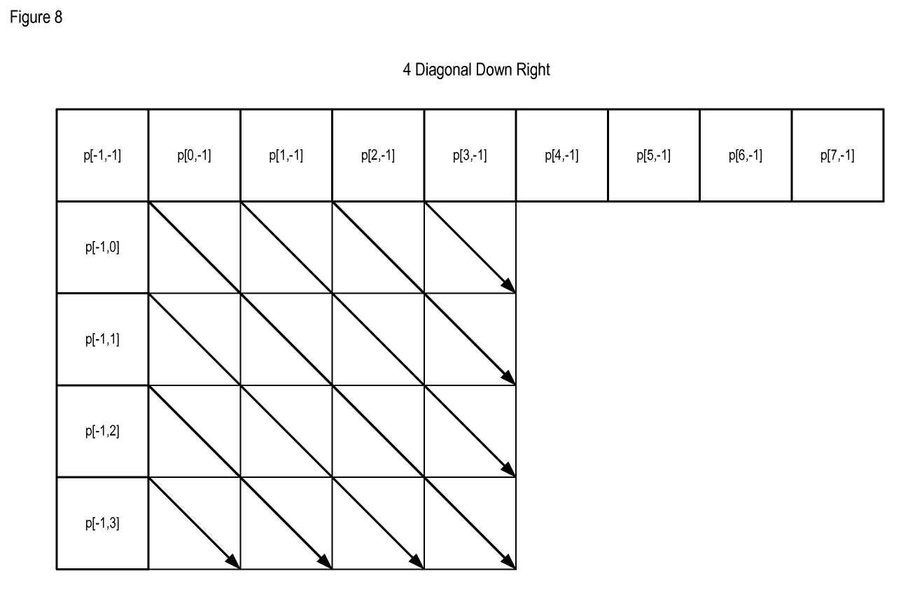

FIG. 8 depicts a graphical illustration of the H.264 Intra_{—}4×4_Diagonal_Down_Right prediction mode, which illustrates that the pixels to be predicted are based on the pixels above them and to the left. Although the parallel lines might appear that the prediction of the pixels is straightforward, there is a substantial difference in the structure of the formulas for predicting the various pixels. In particular, the H.264 standard specifies that:

pred4×4L[x,y]=(p[x−y−2,−1]+2*p[x−y−1,−1]+p[x−y,−1]+2)>>2 (8-53)

when x is greater than y, and

pred4×4L[x,y]=(p[−1,y=x−2]+2*p[−1,y−x−1]+p[−1,y−x]+2)>>2 (8-54)

when x is less than y, and

pred4×4L[x,y]=(p[0,−1]+2*p[−1,−1]+p[−1,0]+2)>>2 (8-55)

when x is equal to y.

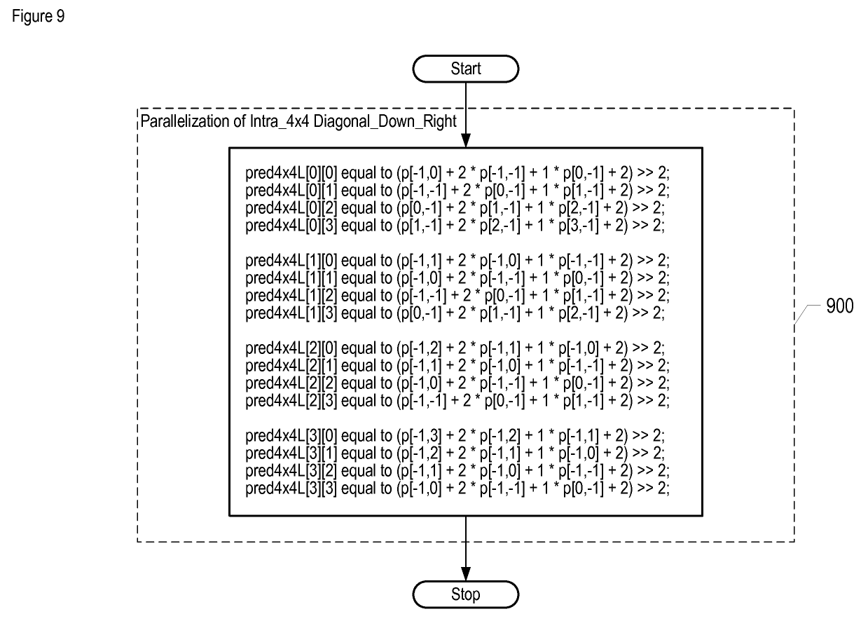

FIG. 9 depicts a flowchart of the salient operations associated with the parallelization of the H.264 Intra_{—}4×4_Diagonal_Down_Right prediction mode.

At task 900, the illustrative embodiment sets all 16 pixels of the array pred4×4L in accordance with the 16 formulas shown in FIG. 9. In accordance with the illustrative embodiment, all 16 pixels of the array pred4×4L are set simultaneously and in parallel in different execution units in a single-instruction, multiple-data processor. It will be clear to those skilled in the art, after reading this specification, how to do this.

The ability to parallelize the H.264 Intra_{—}4×4_Diagonal_Down_Right prediction is noteworthy because of the diversity in the structures of the formulas for predicting the various pixels. For this reason, the ability to set, for example, pred4×4L[0,0], pred4×4L[0,1], and pred4×4L[1,0] in parallel execution enables the H.264 Intra_{—}4×4_Diagonal_Down_Right prediction to be performed far more quickly on a SIMD processor than it had been previously envisioned.

In some alternative embodiments of the present invention (e.g., in single-instruction/single-data processors, single-instruction/multiple-data processors having fewer than 16 execution units, and multiple-instruction/multiple-data processors having fewer than 16 execution units, etc.) any subcombination of the 16 pixels of the array pred4×4L can be set simultaneously.

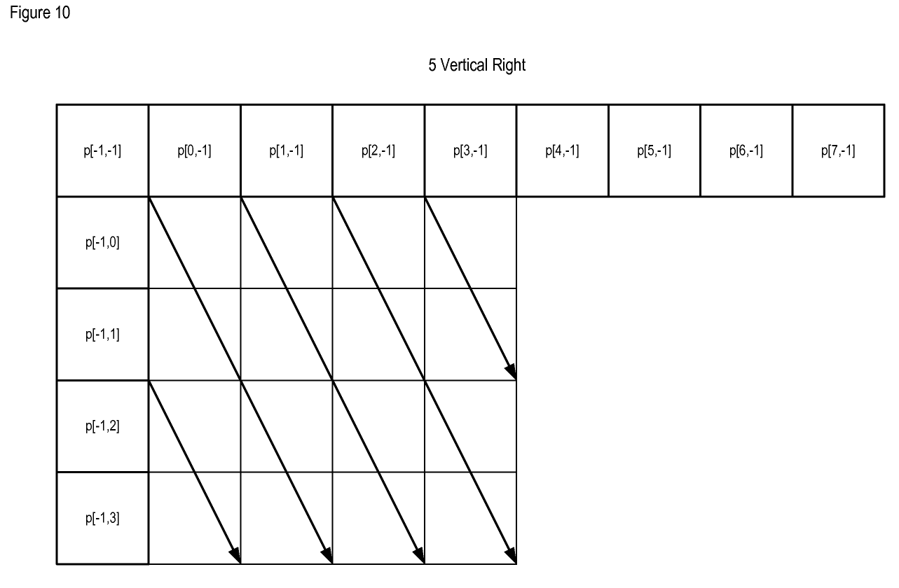

FIG. 10 depicts a graphical illustration of the H.264 Intra_{—}4×4_Vertical_Right prediction mode, which illustrates that the pixels to be predicted are based on the pixels above them and to the left. Although the parallel lines might appear that the prediction of the pixels is straightforward, there is a substantial difference in the structure of the formulas for predicting the various pixels. In particular, the H.264 standard specifies that:

$$\begin{matrix}pred 4 \times 4 L [ x , y ] = ( p [ x - ( y >> 1 ) - 1 , - 1 ] + p [ x - ( y >> 1 ) , - 1 ] + 1 ) >> 1 \\ when 2 * x - y ∈ \{ 0 , 2 , 4 , 6 \} , and & ( 8 \text{-} 56 ) \\ pred 4 \times 4 L [ x , y ] = ( p [ x - ( y >> 1 ) - 2 , - 1 ] + 2 * p [ x - ( y >> 1 ) - 1 , - 1 ] + p [ x - ( y >> 1 ) , - 1 ] + 2 ) >> 2 \\ when 2 * x - y ∈ \{ 1 , 3 , 5 \} , and & ( 8 \text{-} 57 ) \\ pred 4 \times 4 L [ x , y ] = ( p [ - 1 , 0 ] + 2 * p [ - 1 , - 1 ] + p [ 0 , - 1 ] + 2 ) >> 2 \\ when 2 * x - y = - 1 , and & ( 8 \text{-} 58 ) \\ pred 4 \times 4 L [ x , y ] = ( p [ - 1 , y - 1 ] + 2 * p [ - 1 , y - 2 ] + p [ - 1 , y - 3 ] + 2 ) >> 2 \\ when 2 * x - y ∈ \{ - 2 , - 3 \} . & ( 8 \text{-} 59 )\end{matrix}$$

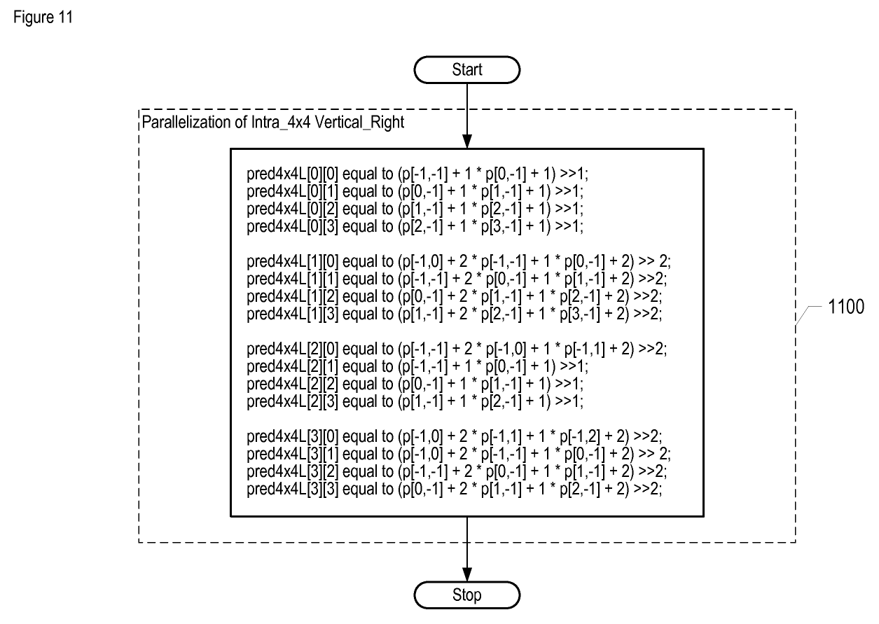

FIG. 11 depicts a flowchart of the salient operations associated with the parallelization of the H.264 Intra_{—}4×4_Vertical_Right prediction mode.

At task 1100, the illustrative embodiment sets all 16 pixels of the array pred4×4L in accordance with the 16 formulas shown in FIG. 11. In accordance with the illustrative embodiment, all 16 pixels of the array pred4×4L are set simultaneously and in parallel in different execution units in a single-instruction, multiple-data processor. It will be clear to those skilled in the art, after reading this specification, how to do this.

The ability to parallelize the H.264 Intra_{—}4×4_Vertical_Right prediction is noteworthy because of the diversity in the structures of the formulas for predicting the various pixels. For this reason, the ability to set, for example, pred4×4L[0, 0], pred4×4L[0, 1], pred4×4L[0, 2], and pred4×4L[1, 1] in parallel execution enables the H.264 Intra_{—}4×4_Vertical_Right prediction to be performed far more quickly on a SIMD processor than it had been previously envisioned.

In some alternative embodiments of the present invention (e.g., in single-instruction/single-data processors, single-instruction/multiple-data processors having fewer than 16 execution units, and multiple-instruction/multiple-data processors having fewer than 16 execution units, etc.) any subcombination of the 16 pixels of the array pred4×4L can be set simultaneously.

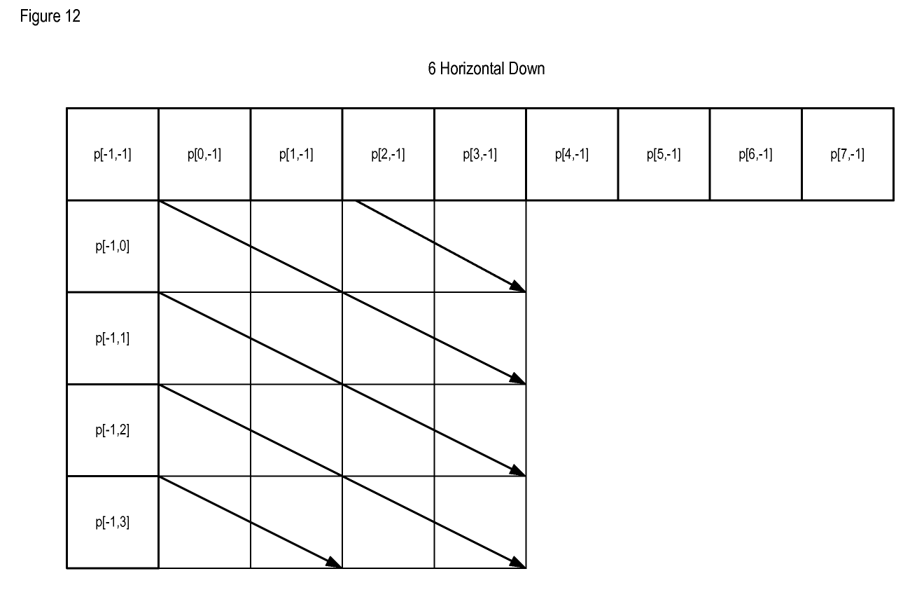

FIG. 12 depicts a graphical illustration of the H.264 Intra_{—}4×4_Horizontal_Down prediction mode, which illustrates that the pixels to be predicted are based on the pixels above them and to the left. Although the parallel lines might appear that the prediction of the pixels is straightforward, there is a substantial difference in the structure of the formulas for predicting the various pixels. In particular, the H.264 standard specifies that:

$$\begin{matrix}pred 4 \times 4 L [ x , y ] = ( p [ - 1 , y - ( x >> 1 ) - 1 ] + p [ - 1 , y - ( x >> 1 ) ] + 1 ) >> 1 \\ when 2 * y - x ∈ \{ 0 , 2 , 4 , 6 \} , and & ( 8 \text{-} 60 ) \\ pred 4 \times 4 L [ x , y ] = ( p [ - 1 , y - 1 ( x >> 1 ) - 2 ] + 2 * p [ - 1 , y - ( >> 1 ) - 1 ] + p [ ( - 1 , y - ( x >> 1 ) ] + 2 ) >> 2 \\ when 2 * y - x ∈ \{ 1 , 3 , 5 \} , and & ( 8 \text{-} 61 ) \\ pred 4 \times 4 L [ x , y ] = ( p [ - 1 , 0 ] + 2 * p [ - 1 , - 1 ] + p [ 0 , - 1 ] + 2 ) >> 2 \\ when 2 * y - x = - 1 , and & ( 8 \text{-} 62 ) \\ pred 4 \times 4 L [ x , y ] = ( p [ x - 1 , - 1 ] + 2 * p [ x - 2 , - 1 ] + p [ x - 3 , - 1 ] + 2 ) >> 2 \\ when 2 * y - x ∈ \{ - 2 , - 3 \} . & ( 8 \text{-} 63 )\end{matrix}$$

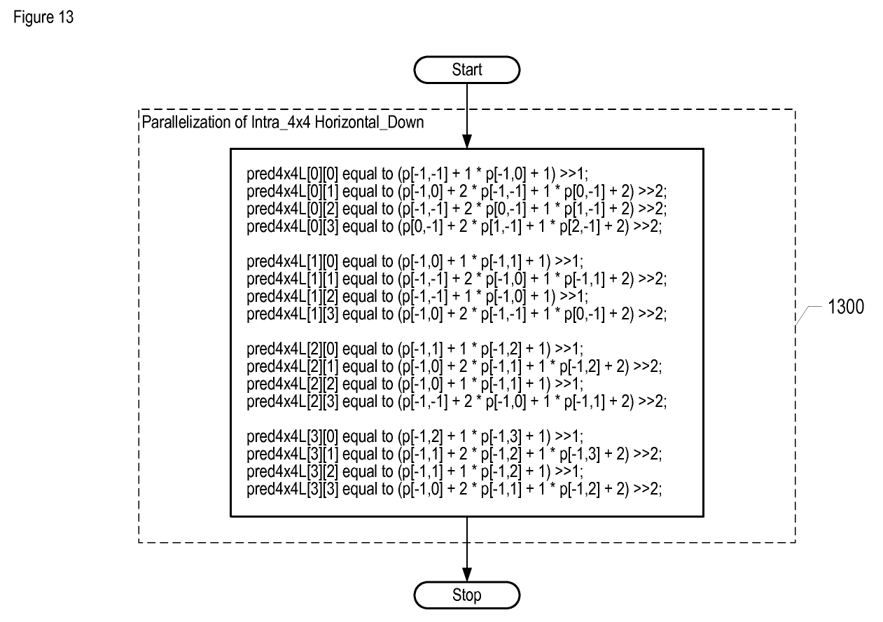

FIG. 13 depicts a flowchart of the salient operations associated with the parallelization of the H.264 Intra_{—}4×4_Horizontal_Down prediction mode.

At task 1300, the illustrative embodiment sets all 16 pixels of the array pred4×4L in accordance with the 16 formulas shown in FIG. 13. In accordance with the illustrative embodiment, all 16 pixels of the array pred4×4L are set simultaneously and in parallel in different execution units in a single-instruction, multiple-data processor. It will be clear to those skilled in the art, after reading this specification, how to do this.

The ability to parallelize the H.264 Intra_{—}4×4_Horizontal_Down prediction is noteworthy because of the diversity in the structures of the formulas for predicting the various pixels. For example For this reason, the ability to set, for example, pred4×4L[0, 0], pred4×4L[0, 1], pred4×4L[0, 2], and pred4×4L[1, 1] in parallel execution enables the H.264 Intra_{—}4×4_Horizontal_Down prediction to be performed far more quickly on a SIMD processor than it had been previously envisioned.

In some alternative embodiments of the present invention (e.g., in single-instruction/single-data processors, single-instruction/multiple-data processors having fewer than 16 execution units, and multiple-instruction/multiple-data processors having fewer than 16 execution units, etc.) any subcombination of the 16 pixels of the array pred4×4L can be set simultaneously.

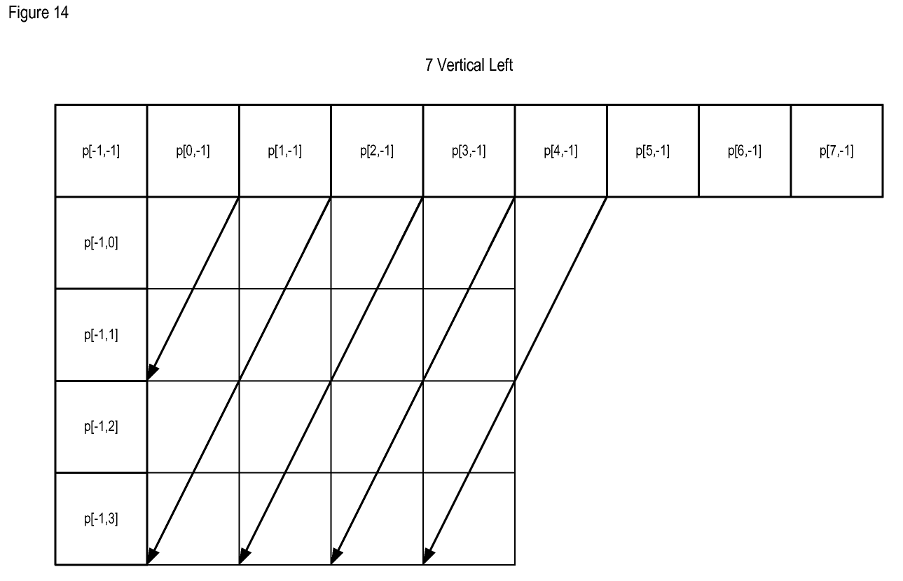

FIG. 14 depicts a graphical illustration of the H.264 Intra_{—}4×4_Vertical_Left prediction mode, which illustrates that the pixels to be predicted are based on the pixels above them and to the right. Although the parallel lines might appear that the prediction of the pixels is straightforward, there is a substantial difference in the structure of the formulas for predicting the various pixels. In particular, the H.264 standard specifies that:

$$\begin{matrix}pred 4 \times 4 L [ x , y ] = ( p [ x + ( y >> 1 ) , - 1 ] + p [ x + ( y >> 1 ) + 1 , - 1 ] + 1 ) >> 1 \\ when y ∈ \{ 0 , 2 \} , and & ( 8 \text{-} 64 ) \\ pred 4 \times 4 L [ x , y ] = ( p [ x + ( y >> 1 ) , - 1 ] + 2 * p [ x + ( y >> 1 ) + 1 , - 1 ] + p [ ( x + ( y >> 1 ) + 2 , - 1 ] + 2 ) >> 2 \\ when y ∈ \{ 1 , 3 \} . & ( 8 \text{-} 65 )\end{matrix}$$

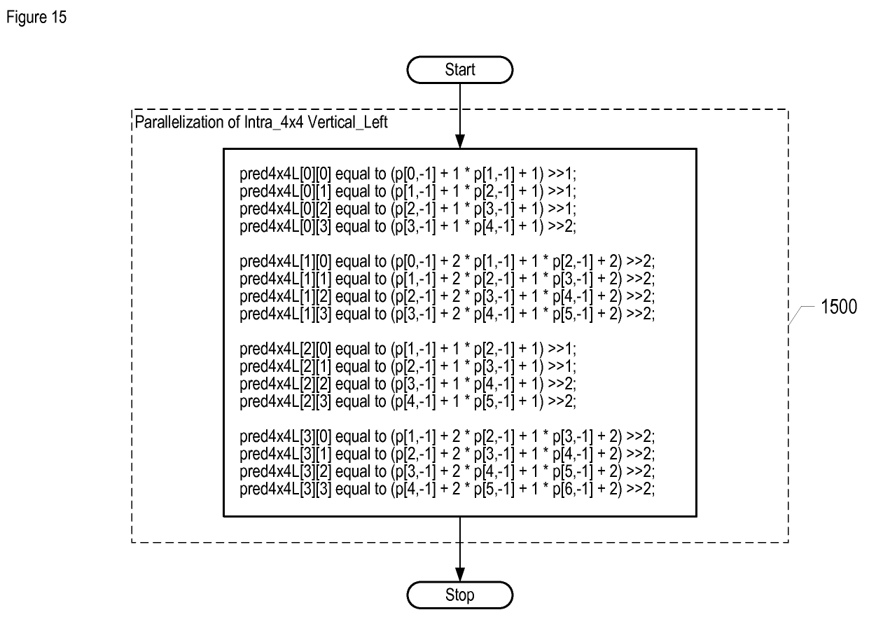

FIG. 15 depicts a flowchart of the salient operations associated with the parallelization of the H.264 Intra_{—}4×4_Vertical_Left prediction mode.

At task 1500, the illustrative embodiment sets all 16 pixels of the array pred4×4L in accordance with the 16 formulas shown in FIG. 15. In accordance with the illustrative embodiment, all 16 pixels of the array pred4×4L are set simultaneously and in parallel in different execution units in a single-instruction, multiple-data processor. It will be clear to those skilled in the art, after reading this specification, how to do this. The ability to parallelize the H.264 Intra_{—}4×4_Vertical_Left prediction is noteworthy because of the diversity in the structures of the formulas for predicting the various pixels. For this reason, the ability to set, for example, pred4×4L[0, 0] and pred4×4L[0, 1] in parallel execution enables the H.264 Intra_{—}4×4_Vertical_Left prediction to be performed far more quickly on a SIMD processor than it had been previously envisioned.

In some alternative embodiments of the present invention (e.g., in single-instruction/single-data processors, single-instruction/multiple-data processors having fewer than 16 execution units, and multiple-instruction/multiple-data processors having fewer than 16 execution units, etc.) any subcombination of the 16 pixels of the array pred4×4L can be set simultaneously.

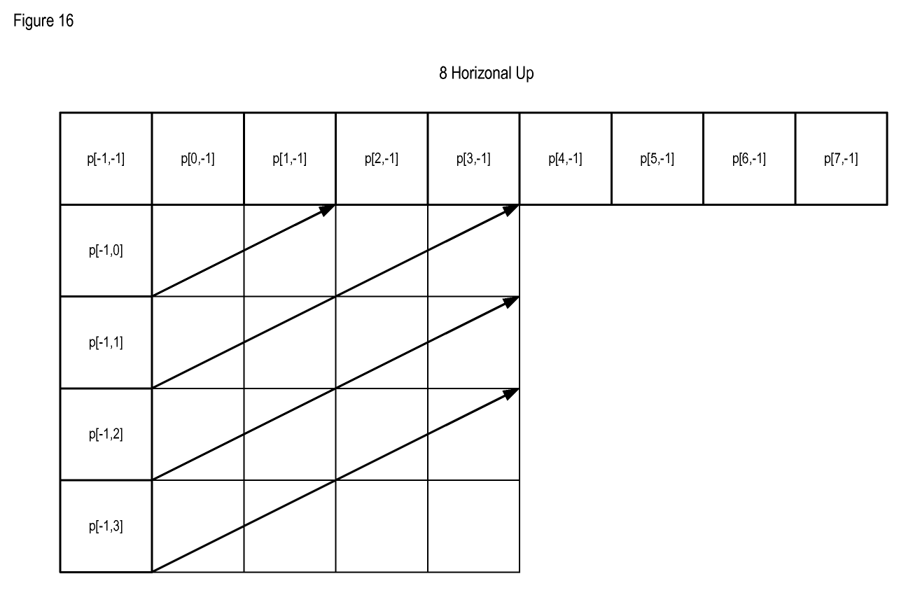

FIG. 16 depicts a graphical illustration of the H.264 Intra_{—}4×4_Horizontal_Up prediction mode, which illustrates that the pixels to be predicted are based on the pixels below them and to the left. Although the parallel lines might appear that the prediction of the pixels is straightforward, there is a substantial difference in the structure of the formulas for predicting the various pixels. In particular, the H.264 standard specifies that:

$$\begin{matrix}pred 4 \times 4 L [ x , y ] = ( p [ - 1 , y + ( x >> 1 ) ] + p [ - 1 , y + ( x >> 1 ) + 1 ] + 1 ) >> 1 \\ when x + 2 * y ∈ \{ 0 , 2 , 4 \} , and & ( 8 \text{-} 66 ) \\ pred 4 \times 4 L [ x , y ] = ( p [ - 1 , y + ( x >> 1 ) ] + 2 * p [ - 1 , y + ( x >> 1 ) + 1 ] + p [ - 1 , y + [ ( x >> 1 ) + 2 ] + 2 ) >> 2 \\ when x + 2 * y ∈ \{ 1 , 3 \} , and & ( 8 \text{-} 67 ) \\ pred 4 \times 4 L [ x , y ] = ( p [ - 1 , 2 ] + 3 * p [ - 1 , 3 ] + 2 ) >> 2 \\ when x + 2 * y ∈ \{ 5 \} , and & ( 8 \text{-} 68 ) \\ pred 4 \times 4 L [ x , y ] = ( p [ - 1 , 3 ] \\ when x + 2 * ∈ \{ 6 , 7 , 8 , 9 \} . & ( 8 \text{-} 69 )\end{matrix}$$

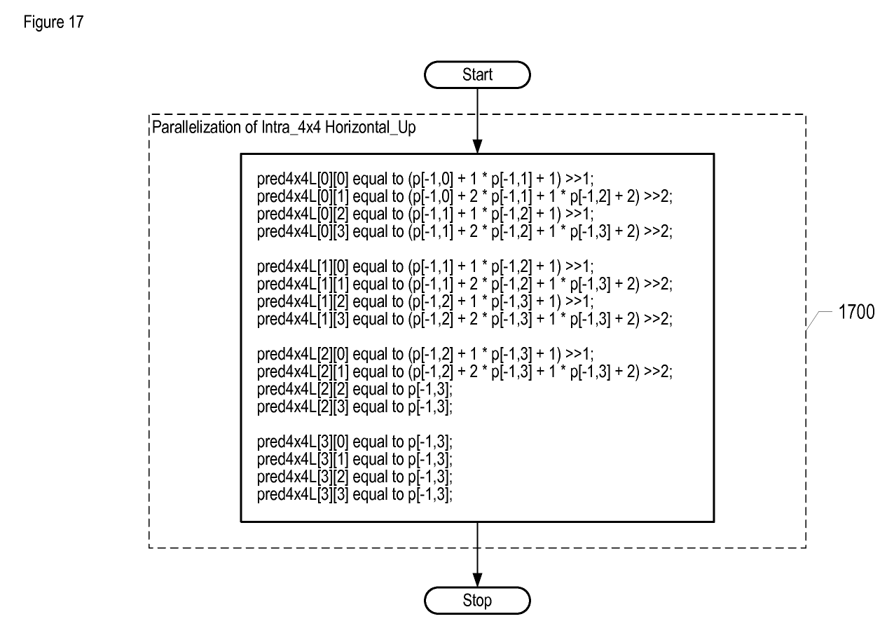

FIG. 17 depicts a flowchart of the salient operations associated with the parallelization of the H.264 Intra_{—}4×4_Horizontal_Up prediction mode.

At task 1700, the illustrative embodiment sets all 16 pixels of the array pred4×4L in accordance with the 16 formulas shown in FIG. 17. In accordance with the illustrative embodiment, all 16 pixels of the array pred4×4L are set simultaneously and in parallel in different execution units in a single-instruction, multiple-data processor. It will be clear to those skilled in the art, after reading this specification, how to do this. The ability to parallelize the H.264 Intra_{—}4×4_Horizontal_Up prediction is noteworthy because of the diversity in the structures of the formulas for predicting the various pixels. For this reason, the ability to set, for example, pred4×4L[0, 0], pred4×4L[1,0], pred4×4L[1, 2], and pred4×4L[3, 3] in parallel execution enables the H.264 Intra_{—}4×4_Horizontal_Up prediction to be performed far more quickly on a SIMD processor than it had been previously envisioned.

In some alternative embodiments of the present invention (e.g., in single-instruction/single-data processors, single-instruction/multiple-data processors having fewer than 16 execution units, and multiple-instruction/multiple-data processors having fewer than 16 execution units, etc.) any subcombination of the 16 pixels of the array pred4×4L can be set simultaneously.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A method of parallelizing the Intra_{—}4×4 Diagonal_Down_Left prediction of a 4×4 luma block, pred4×4L[ ], said method comprising:
setting pred4×4L[3, 2] using the formula (sample p[5,−1]+sample p[7,−1]+2* (sample p[6,−1])+2)>>2; and
setting pred4×4L[3, 3] using the formula (sample p[6,−1]+sample p[7,−1]+2* (sample p[7,−1])+2)>>2.

2. The method of claim 1 wherein said pixels pred4×4L[3,2] and pred4×4L[3,3] are set in different execution units in a single-instruction, multiple-data processor at different times.

3. The method of claim 1 wherein said pixels pred4×4L[3,2] and pred4×4L[3,3] are set simultaneously and in parallel in different execution units in a single-instruction, multiple-data processor.

4. A method of parallelizing the Intra_{—}4×4 Diagonal_Down_Right prediction of a 4×4 luma block, pred4×4L[ ], said method comprising:
setting pred4×4L[0,0] using the formula (sample p[−1,0]+2*sample p[−1,−1]+sample p[0,−1]+2)>>2;
setting pred4×4L[0,1] using the formula (sample p[−1,−1]+2*sample p[0,−1]+sample p[1,−1]+2)>>2.

5. The method of claim 4 further comprising:
setting pred4×4L[1,0] using the formula (sample p[−1,1]+2*sample p[−1,0]+sample p[−1,−1]+2)>>2.

6. The method of claim 4 wherein said pixels pred4×4L[0,0], and pred4×4L[0,1] are set in different execution units in a single-instruction, multiple-data processor at the same time.

7. The method of claim 4 wherein said pixels pred4×4L[0,0], and pred4×4L[0,1] are set in different execution units in a single-instruction, multiple-data processor at different times.

8. A method of parallelizing the Intra_{—}4×4 Vertical_Right prediction of a 4×4 luma block, pred4×4L[ ], said method comprising:
setting pred4×4L[0, 0] using the formula (sample p[−1,−1]+1*sample p[0,−1]+1)>>1; and
setting pred4×4L[0, 1] using the formula (sample p[0,−1]+1*sample p[1,−1]+1)>>1.

9. The method of claim 8 further comprising:
setting pred4×4L[0, 2] using the formula (sample p[1,−1]+1*sample p[2,−1]+1)>>1; and
setting pred4×4L[1, 1] using the formula (sample p[−1,−1]+2*sample p[0,−1]+sample p[1,−1]+2)>>2.

10. The method of claim 8 wherein said pixels pred4×4L[0,0], and pred4×4L[0,1] are set in different execution units in a single-instruction, multiple-data processor at the same time.

11. The method of claim 8 wherein said pixels pred4×4L[0,0], and pred4×4L[0,1] are set in different execution units in a single-instruction, multiple-data processor at different times.

12. A method of parallelizing the Intra_{—}4×4 Vertical_Right prediction of a 4×4 luma block, pred4×4L[ ], said method comprising:
setting pred4×4L[0, 0] using the formula (sample p[−1,−1]+1*sample p[0,−1]+1)>>1; and
setting pred4×4L[1, 1] using the formula (sample p[−1,−1]+2*sample p[0,−1]+sample p[1,−1]+2)>>2.

13. The method of claim 12 further comprising:
setting pred4×4L[0, 1] using the formula (sample p[0,−1]+1*sample p[1,−1]+1)>>1; and
setting pred4×4L[0, 2] using the formula (sample p[1,−1]+1*sample p[2,−1]+1)>>1.

14. The method of claim 12 wherein said pixels pred4×4L[0,0], and pred4×4L[1,1] are set in different execution units in a single-instruction, multiple-data processor at the same time.

15. The method of claim 12 wherein said pixels pred4×4L[0,0], and pred4×4L[1,1] are set in different execution units in a single-instruction, multiple-data processor at different times.

16. A method of parallelizing the Intra_{—}4×4 Horizontal_Down prediction of a 4×4 luma block, pred4×4L[ ], said method comprising:
setting pred4×4L[0, 0] using the formula (sample p[−1,−1]+1*sample p[−1,0]+1)>>1; and
setting pred4×4L[1, 0] using the formula (sample p[−1,0]+1*sample p[−1,1]+1)>>1.

17. The method of claim 16 further comprising:
setting pred4×4L[1, 1] using the formula (sample p[−1,−1]+2*sample p[−1,0]+sample p[−1,1]+2)>>2; and
setting pred4×4L[2, 0] using the formula (sample p[−1,1]+1*sample p[−1,2]+1)>>1.

18. The method of claim 16 wherein said pixels pred4×4L[0,0], and pred4×4L[1,0] are set in different execution units in a single-instruction, multiple-data processor at the same time.

19. The method of claim 16 wherein said pixels pred4×4L[0,0], and pred4×4L[1,0] are set in different execution units in a single-instruction, multiple-data processor at different times.

20. A method of parallelizing the Intra_{—}4×4 Horizontal_Down prediction of a 4×4 luma block, pred4×4L[ ], said method comprising:
setting pred4×4L[0, 0] using the formula (sample p[−1,−1]+1*sample p[−1,0]+1)>>1; and
setting pred4×4L[1, 1] using the formula (sample p[−1,−1]+2*sample p[−1,0]+sample p[−1,1]+2)>>2.

21. The method of claim 20 further comprising:
setting pred4×4L[1, 0] using the formula (sample p[−1,0]+1*sample p[−1,1]+1)>>1; and
setting pred4×4L[2, 0] using the formula (sample p[−1,1]+1*sample p[−1,2]+1)>>1.

22. The method of claim 21 wherein said pixels pred4×4L[0,0], and pred4×4L[1,1] are set in different execution units in a single-instruction, multiple-data processor at the same time.

23. The method of claim 22 wherein said pixels pred4×4L[0,0], and pred4×4L[1,1] are set in different execution units in a single-instruction, multiple-data processor at different times.

24. A method of parallelizing the Intra_{—}4×4 Vertical_Left prediction of a 4×4 luma block, pred4×4L[ ], said method comprising:
setting pred4×4L[0, 0] equal to (sample p[0,−1]+1*sample p[1,−1]+1)>>1; and
setting pred4×4L[0, 1] equal to (sample p[1,−1]+1*sample p[2,−1]+1)>>1.

25. The method of claim 24 further comprising:
setting pred4×4L[1, 0] equal to (sample p[0,−1]+2*sample p[1,−1]+1*sample p[2,−1]+2)>>2; and
setting pred4×4L[1, 1] equal to (sample p[1,−1]+2*sample p[2,−1]+1*sample p[3,−1]+2)>>2.

26. The method of claim 24 wherein said pixels pred4×4L[0,0], and pred4×4L[0,1] are set in different execution units in a single-instruction, multiple-data processor at the same time.

27. The method of claim 24 wherein said pixels pred4×4L[0,0], and pred4×4L[0,1] are set in different execution units in a single-instruction, multiple-data processor at different times.

28. A method of parallelizing the Intra_{—}4×4 Vertical_Left prediction of a 4×4 luma block, pred4×4L[ ], said method comprising:
setting pred4×4L[0, 0] equal to (sample p[0,−1]+1*sample p[1,−1]+1)>>1; and
setting pred4×4L[1, 1] equal to (sample p[1,−1]+2*sample p[2,−1]+1*sample p[3,−1]+2)>>2.

29. The method of claim 28 further comprising:
setting pred4×4L[1, 0] equal to (sample p[0,−1]+2*sample p[1,−1]+1*sample p[2,−1]+2)>>2; and
setting pred4×4L[0, 1] equal to (sample p[1,−1]+1*sample p[2,−1]+1)>>1.

30. The method of claim 28 wherein said pixels pred4×4L[0,0], and pred4×4L[1,1] are set in different execution units in a single-instruction, multiple-data processor at the same time.

31. The method of claim 28 wherein said pixels pred4×4L[0,0], and pred4×4L[1,1] are set in different execution units in a single-instruction, multiple-data processor at different times.

32. A method of parallelizing the Intra_{—}4×4 Horizontal_Up prediction of a 4×4 luma block, pred4×4L[ ], said method comprising:
setting pred4×4L[0, 0] equal to (sample p[−1,0]+1*sample p[−1,1]+1)>>1; and
setting pred4×4L[1, 0] equal to (sample p[−1,1]+1*sample p[−1,2]+1)>>1.

33. The method of claim 32 further comprising setting pred4×4L[1, 2] equal to (sample p[−1,2]+1*sample p[−1,3]+1)>>1.

34. The method of claim 32 wherein said pixels pred4×4L[0,0], and pred4×4L[1,0] are set in different execution units in a single-instruction, multiple-data processor at the same time.

35. The method of claim 32 wherein said pixels pred4×4L[0,0], and pred4×4L[1,0] are set in different execution units in a single-instruction, multiple-data processor at different times.

36. A method of parallelizing the Intra_{—}4×4 Horizontal_Up prediction of a 4×4 luma block, pred4×4L[ ], said method comprising:
setting pred4×4L[0, 0] equal to (sample p[−1,0]+1*sample p[−1,1]+1)>>1; and
setting pred4×4L[1, 2] equal to (sample p[−1,2]+1*sample p[−1,3]+1)>>1.

37. The method of claim 36 further comprising setting pred4×4L[1, 0] equal to (sample p[−1,1]+1*sample p[−1,2]+1)>>1.

38. The method of claim 36 wherein said pixels pred4×4L[0,0], and pred4×4L[1,2] are set in different execution units in a single-instruction, multiple-data processor at the same time.

39. The method of claim 36 wherein said pixels pred4×4L[0,0], and pred4×4L[1,2] are set in different execution units in a single-instruction, multiple-data processor at different times.
